(19) United States
(12) Patent Application Publication
(10) Pub. No.: US 2026/0171724 A1
(43) Pub. Date: Jun. 18, 2026

(54) CONNECTOR

(71) Applicant: SUMITOMO WIRING SYSTEMS, LTD., Mie (JP)

(72) Inventor: Woosun CHOI, Mie (JP)

(21) Appl. No.: 19/421,520

(22) Filed: Dec. 16, 2025

(30) Foreign Application Priority Data
Dec. 18, 2024 (JP) 2024-221537

(51) Int. Cl. H01R 13/641; H01R 13/629

(52) U.S. Cl. CPC H01R 13/641; H01R 13/629

(57) ABSTRACT

A connector enables the completion of mating to be detected. The connector includes a first connector and a second connector. The first housing includes a first main body and a first locking portion. The second housing includes a peripheral wall and a second locking portion. The first connector includes an outer surface that faces the peripheral wall when the peripheral wall is covered by the first main body, a first code provided on the outer surface, and a second code that contains different information from the first code and is disposed on the outer surface so as to surround the first code. The peripheral wall includes an exposure hole that is disposed to expose the first code and cover the second code when mating of the first connector and the second connector has been completed by the first locking portion and the second locking portion.

### CROSS-REFERENCE TO RELATED APPLICATIONS

This application is based on and claims priority from Japanese Patent Application No. 2024-221537, filed on Dec. 18, 2024, with the Japan Patent Office, the disclosure of which is incorporated herein in its entirety by reference.

### TECHNICAL FIELD

The present disclosure relates to a connector.

### BACKGROUND

Japanese Patent Laid-open Publication No. 2023-046756 cited below describes a connector including a housing that can be mated with a mating connector and an identifier that is visibly disposed on the outer surface of the housing. By accessing the exposed identifier, it is possible to detect and record that mating with the mating connector has been completed.

### SUMMARY

There is demand for an identifier provided on a connector to make the completion of mating with a mating connector detectable by way of a code.

It is an object of the present disclosure to provide a connector that enables the completion of mating to be detected using a code.

A connector according to an aspect of the present disclosure is a connector including: a first connector including a first housing; and a second connector including a second housing into which the first housing is inserted, wherein the first housing includes a first main body, which is inserted into the second housing, and a first locking portion, the second housing includes a peripheral wall, which covers the first main body, and a second locking portion, the first connector includes an outer surface that faces the peripheral wall in a state where the first main body is covered by the peripheral wall, a first code that is provided on the outer surface, and a second code that includes different information from the first code and is disposed on the outer surface so as to surround the first code, and the peripheral wall includes an exposure hole that is disposed to expose the first code and cover the second code in a state where mating of the first connector and the second connector has been completed by the first locking portion and the second locking portion.

The connector according to an aspect of the present disclosure enables the completion of mating to be detected using a code.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view depicting a first connector and a second connector of a connector according to an embodiment of the present disclosure.

FIG. 2 is a plan view of the first connector and the second connector appearing in FIG. 1.

FIG. 3 is a plan view of a mated state of the first connector and the second connector appearing in FIG. 1.

FIG. 4 is a cross-sectional view along a line 4-4 in FIG. 3.

FIG. 5 is a cross-sectional view along a line 5-5 in FIG. 3.

FIG. 6 is a plan view depicting a state where the first connector and the second connector appearing in FIG. 1 are not mated.

FIG. 7 is a cross-sectional view of the first connector and the second connector in FIG. 6.

FIG. 8 is an enlarged plan view of an identifier appearing in FIG. 2.

FIG. 9 is a plan view depicting an example of a first code and a second code included in the identifier appearing in FIG. 8.

FIG. 10 is a plan view depicting the second code in FIG. 9.

FIG. 11 is a plan view in which part of the connector in FIG. 3 is enlarged, and depicts the state of an exposure hole of a second housing and the first code and the second code.

FIG. 12 is a diagram useful in explaining the first connector and second connector before mating, and how the first code and second code are read.

FIG. 13 is a plan view depicting a connector-mated state of a first connector and a second connector according to a modification.

FIG. 14 is a side view depicting a connector-mated state of a first connector and a second connector according to a modification.

FIG. 15 is a bottom view depicting a connector-mated state of a first connector and a second connector according to a modification.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Outline of Embodiments of the Present Disclosure

Several embodiments of the present disclosure will first be listed and described in outline.

(1) A connector according to an aspect of the present disclosure includes: a first connector including a first housing; and a second connector including a second housing into which the first housing is inserted, wherein the first housing includes a first main body, which is inserted into the second housing, and a first locking portion, the second housing includes a peripheral wall, which covers the first main body, and a second locking portion, the first connector includes an outer surface that faces the peripheral wall in a state where the first main body is covered by the peripheral wall, a first code that is provided on the outer surface, and a second code that includes different information from the first code and is disposed on the outer surface so as to surround the first code, and the peripheral wall includes an exposure hole that is disposed to expose the first code and cover the second code in a state where mating of the first connector and the second connector has been completed by the first locking portion and the second locking portion.

With this configuration, in a state where mating of the first connector and the second connector has been completed, the second code is covered by the second housing in the periphery of the exposure hole, and the first code is exposed through the exposure hole. This makes it possible to detect, from the first code, that mating has been completed.

(2) In the connector according to (1) above, the first code and the second code may be composed of a plurality of cells, and the cells of the first code and the cells of the second code may be respectively different sizes.

With this configuration, in a state where the first connector and the second connector are separated from each other, the second code is exposed together with the first code, and since the entire second code whose cells have different sizes is detected, detection of the first code can be prevented.

(3) In the connector according to (2) above, the cells that construct the first code may be smaller than the cells that construct the second code.

With this configuration, since the first code contains information using the cells, the small size of the cells enables the first code to reliably contain the necessary information even when the range of the first code surrounded by the second code is small.

(4) The connector according to any one of (1) to (3) above may further include a non-code region provided between a first region where the first code is disposed and a second region where the second code is disposed.

With this configuration, the non-code region enables the first code to be exposed through the exposure hole while the second code remains covered.

(5) In the connector according to (4) above, the non-code region may be annular and surround the first code.

With the above configuration, the first code can be more reliably exposed through the exposure hole and the second code can be more reliably covered, even when the first connector is misaligned with respect to the second connector.

(6) In the connector according to any one of (1) to (5) above, an area of the first region where the first code is disposed may be 5% or less of an area of a code region where the first code and the second code are disposed.

With the above configuration, in a state where the first code and the second code are exposed, the area of the first region in which the first code is disposed is smaller than the area of the second code, which makes it possible to read the second code more reliably.

(7) In the connector according to any one of (1) to (6) above, the first connector may include a position securing member that is assembled onto the first housing and is allowed to move from a provisional locking position to a full locking position in a state where mating of the first connector and the second connector has been completed.

With the above configuration, when positioned at the provisional locking position, the position securing member enables the first connector and the second connector to be relatively separated, and when positioned at the full locking position, the position securing member prevents the first connector and the second connector from becoming relatively separated.

### Detailed Embodiments of the Present Disclosure

Specific examples of connectors according to the present disclosure are described below with reference to the drawings. For ease of explanation, some components have been exaggerated or simplified in the drawings. The ratios between the dimensions of components may also vary from one drawing to another. The expression “annular” as used in the present specification may refer to any structure that forms a loop, a continuous shape that has no ends, or a substantially loop-shaped structure including a gap, such as a C-shape. Examples of “annular” shapes include, but are not limited to, circles, ellipses, and polygons with sharp or rounded corners. The expression “facing” as used in the present specification refers to surfaces or components that are respectively positioned in front of each other, and includes not only cases where the surfaces or components are positioned entirely in front of each other, but also cases where the surfaces are positioned to be partially in front of each other. The expression “facing” as used in the present specification also includes cases where a separate component is interposed between two facing parts and cases where no component is interposed between the two facing parts. Expressions such as “first,” “second,” and “third” are used in the present specification simply to distinguish between objects and do not assign rankings to them.

### (Configuration of Connector 10)

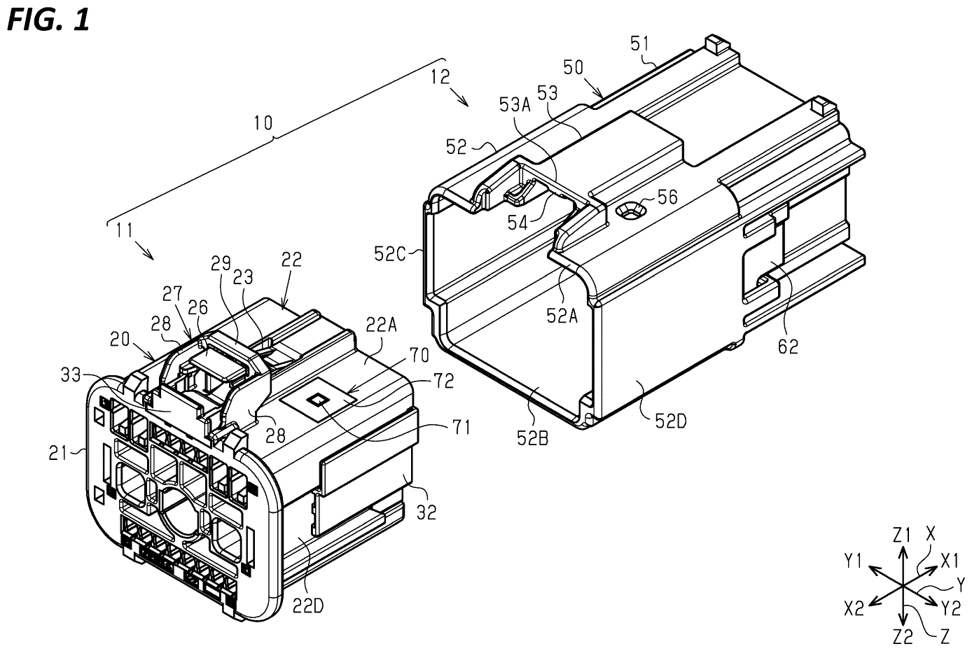

As depicted in FIG. 1, a connector 10 includes a first connector 11 and a second connector 12. The first connector 11 and the second connector 12 are connected by being moved relative to each other along a first axis X. The connector 10 according to the present embodiment is provided in a vehicle, for example.

Note that a first axis X, a second axis Y that is perpendicular to the first axis X, and a third axis Z that is perpendicular to both the first axis X and the second axis Y are indicated in the drawings. A mating direction X1, which is one direction along the first axis X, and an unmating direction X2, which is the opposite direction to the mating direction X1 are also indicated in the drawings. A mounting direction Y1, which is one direction along the second axis Y, and an unmounting direction Y2, which is the opposite direction to the mounting direction Y1, are also indicated in the drawings. An upward direction Z1, which is one direction along the third axis Z, and a downward direction Z2, which is the opposite direction to the upward direction Z1, are also indicated in the drawings.

As depicted in FIGS. 1 to 5, the first connector 11 includes a first housing 20, a first terminal 31, a first retainer 32, and a position securing member 33. The second connector 12 includes a second housing 50, a second terminal 61, and a second retainer 62. As one example, the first terminal 31 is a female terminal and the second terminal 61 is a male terminal.

### (Configuration of First Connector 11)

As depicted in FIGS. 1 to 5, the first housing 20 includes a first main body 21 and a first locking portion 23. The first housing 20 is made of resin.

The first main body 21 includes an outer surface 22. The outer surface 22 includes an upper surface 22A, a lower surface 22B on an opposite side to the upper surface 22A, and a first side surface 22C and a second side surface 22D that connect the upper surface 22A and the lower surface 22B. The shape of first main body 21 is substantially a rectangular cuboid. The first main body 21 accommodates a first terminal 31. The first main body 21 can accommodate a plurality of the first terminals 31. The first main body 21 may also accommodate terminals with different shapes from the first terminals 31. The plurality of first terminals 31 are accommodated in corresponding accommodating portions of the first main body 21. The first retainer 32 is inserted into the first main body 21. The first retainer 32 is made of resin. The first retainer 32 prevents the first terminals 31 from coming out of the first main body 21.

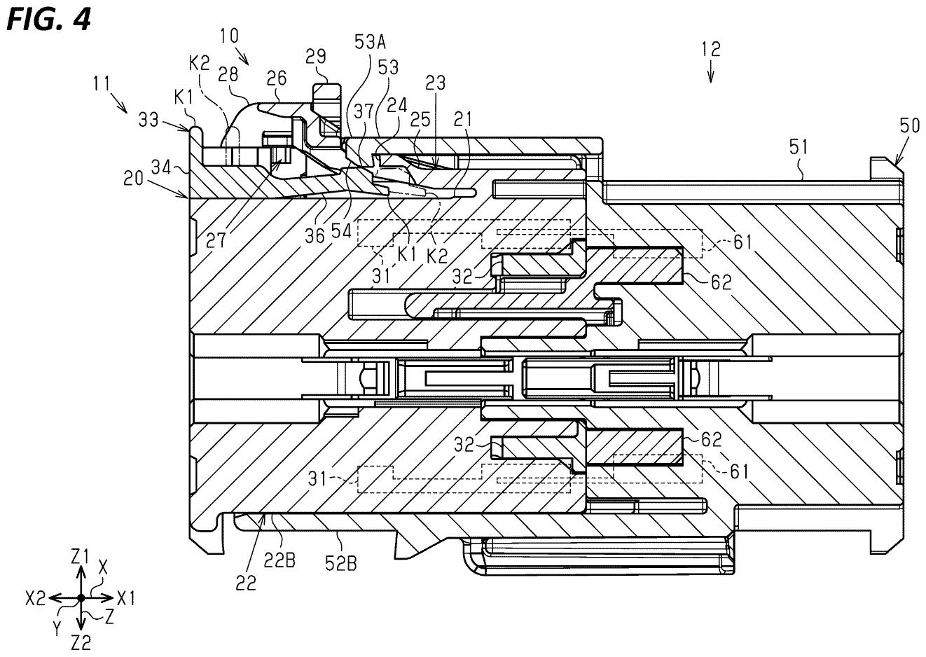

As depicted in FIG. 4, the first locking portion 23 is provided on the upper surface 22A of the first main body 21. As one example, the first locking portion 23 is integrated with the first main body 21. One example of the first locking portion 23 is an elastic piece integrally provided on the first main body 21. The first locking portion 23 is provided in the center along the second axis Y of the upper surface 22A of the first main body 21. The first locking portion 23 first protrudes from the upper surface 22A of the first main body 21 in the upward direction Z1 and then extends in the unmating direction X2, and is capable of elastic deformation in the downward direction Z2.

The first locking portion 23 includes a locking hole 24 in the center along the first axis X. The first locking portion 23 includes, on the mating direction X1-side of the locking hole 24, an ascending slope portion 25 that is inclined in the upward direction Z1 toward the locking hole 24. The first locking portion 23 also includes an operating portion 26 on the unmating direction X2 side of the locking hole 24. The first locking portion 23 is elastically deformed by pressing the ascending slope portion 25 in the downward direction Z2, for example. The first locking portion 23 is also elastically deformed by pressing the operating portion 26 in the downward direction Z2.

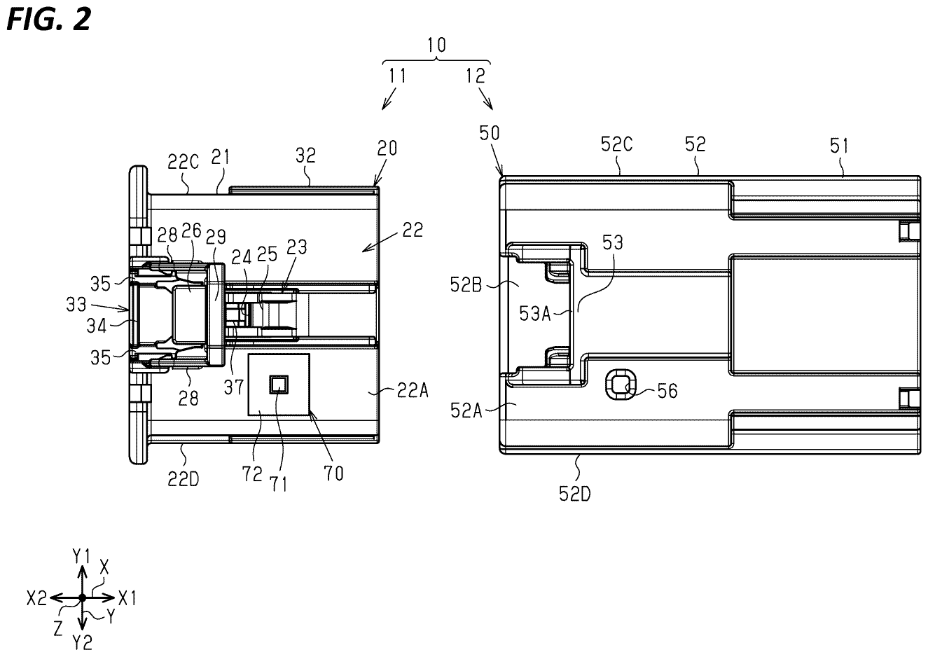

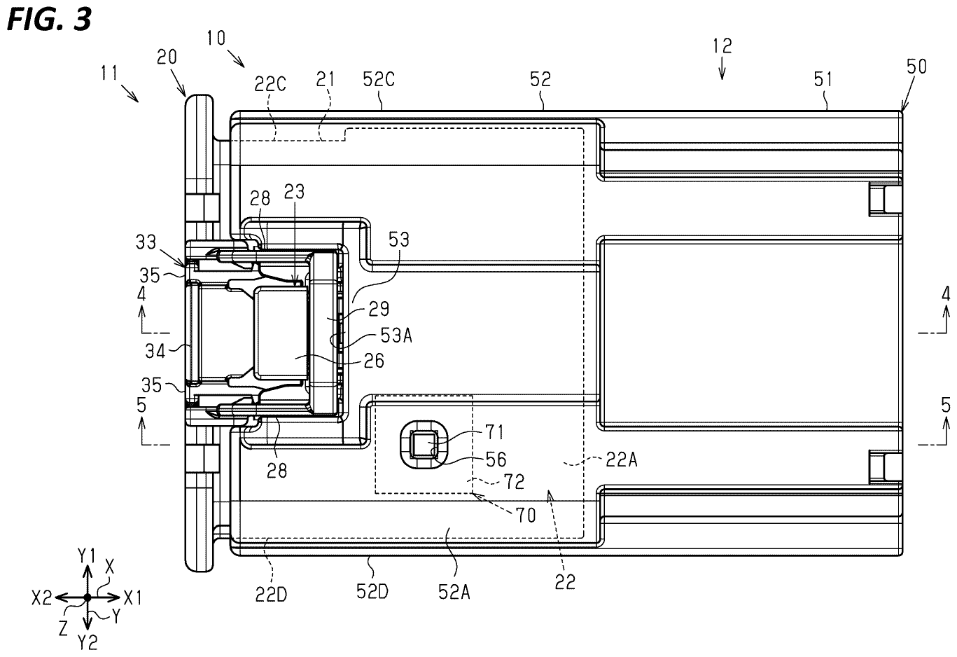

As depicted in FIGS. 1 to 5, the first housing 20 also includes an attachment portion 27 for the position securing member 33 on the upper surface 22A of the first main body 21. The attachment portion 27 includes a pair of side walls 28 that protrude in the upward direction Z1. The pair of side walls 28 are disposed side by side in the second axis Y and extend along the first axis X. As depicted in FIGS. 2 and 3, the pair of side walls 28 are provided so as to sandwich the operating portion 26 of the first locking portion 23. Although not illustrated, the pair of side walls 28 include protruding portions that protrude toward each other from intermediate positions along the first axis X. As depicted in FIGS. 1 to 3, the attachment portion 27 includes a connecting portion 29 that connects the pair of side walls 28.

As depicted in FIGS. 1 to 4, the position securing member 33 is assembled onto the attachment portion 27 of the first housing 20. The position securing member 33 is made of resin. When assembled onto the attachment portion 27, the position securing member 33 is movable in a full locking direction X1 along the first axis X from a provisional locking position K1, which is indicated by a solid line in FIG. 3, to a full locking position K2, which is depicted by a dashed-dotted line in FIG. 4. FIGS. 1, 2, 4 to 7, and 12 depict the position securing member 33 at the provisional locking position K1. Note that the full locking direction X1 in the present embodiment is the same as the mating direction X1 of the first connector 11.

As depicted in FIGS. 3 and 4, the position securing member 33 includes a main body 34, a pair of assembly pieces 35, an action piece 36, and an action protrusion 37. The pair of assembly pieces 35 are disposed on the main body 34 so as to sandwich the main body 34 along the second axis Y. The pair of assembly pieces 35 extend in the full locking direction X1. The pair of assembly pieces 35 are capable of elastically deformation toward the main body 34, which is also toward each other. Although not illustrated, the pair of assembly pieces 35 have mounting protrusions at their front ends that protrude away from each other.

As depicted in FIG. 4, the action piece 36 extends from the main body 34 in the full locking direction X1 so as to be inclined in the upward direction Z1. The action piece 36 is capable of elastic deformation in the downward direction Z2. The action piece 36 includes the action protrusion 37, which protrudes in the upward direction Z1, at its front end.

As depicted in FIG. 2, in a state where the position securing member 33 is at the provisional locking position K1, the action protrusion 37 is provided at a position that is exposed from the locking hole 24 in the first locking portion 23 when looking from a direction along the third axis Z. The action protrusion 37 is provided so that in a state where the position securing member 33 is at the provisional locking position K1 and the first connector 11 has not been inserted into the second connector 12, the action protrusion 37 engages with the locking hole 24 in the full locking direction X1.

### (Configuration of Second Connector 12)

As depicted in FIGS. 1 to 5, the second connector 12 includes a second housing 50, a second terminal 61, and a second retainer 62.

The second housing 50 is made of resin. The second housing 50 includes a second main body 51, a peripheral wall 52, and a second locking portion 53. The shape of the second main body 51 is substantially a rectangular cuboid. As depicted in FIG. 4, the second main body 51 accommodates the second terminal 61. The second main body 51 can accommodate a plurality of the second terminals 61. The plurality of second terminals 61 may include terminals of different shapes corresponding to the plurality of first terminals 31. The plurality of second terminals 61 are accommodated in corresponding accommodating portions of the second main body 51. The second retainer 62 is inserted into the second main body 51. The second retainer 62 is made of resin. The second retainer 62 prevents the second terminals 61 from coming out of the second main body 51.

As depicted in FIGS. 1 to 5, the peripheral wall 52 extends from the second main body 51 in the unmating direction X2. As depicted in FIG. 4, the peripheral wall 52 surrounds front end parts of the second terminals 61. As depicted in FIG. 1, the peripheral wall 52 has a rectangular annular shape when viewed in the mating direction X1. As depicted in FIGS. 3 to 5, the peripheral wall 52 is provided so as to surround the first main body 21 of the first connector 11.

The peripheral wall 52 includes an upper wall 52A, a lower wall 52B, a first side wall 52C, and a second side wall 52D. The upper wall 52A and the lower wall 52B are spaced apart from each other along the third axis Z. The first side wall 52C and the second side wall 52D are spaced apart from each other along the second axis Y. The first side wall 52C and the second side wall 52D connect the upper wall 52A and the lower wall 52B.

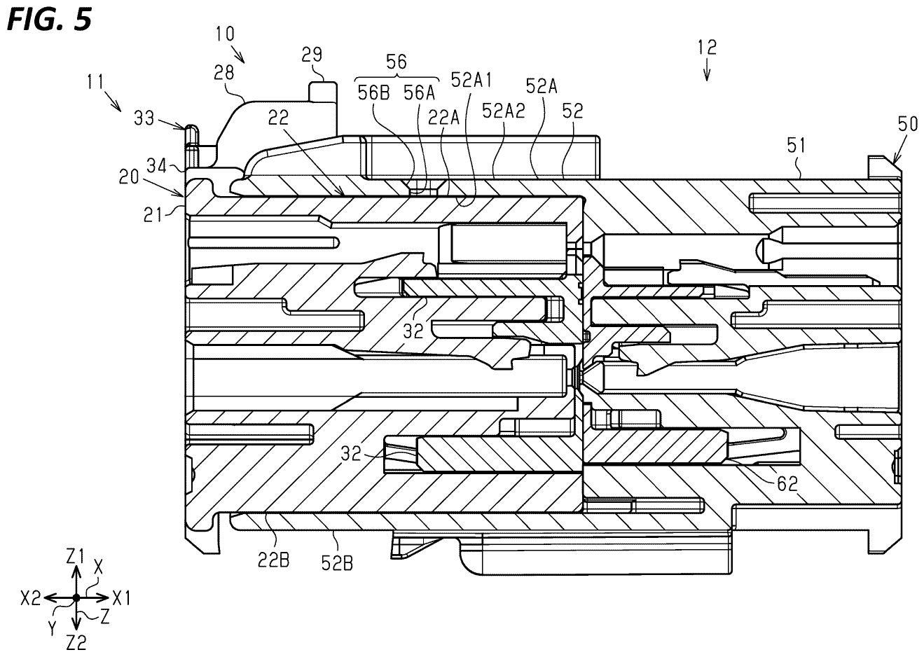

As depicted in FIGS. 2 to 5, the peripheral wall 52 covers the outer surface 22 of the first main body 21. As depicted in FIG. 5, the upper wall 52A of the peripheral wall 52 faces the upper surface 22A of the first main body 21. The lower wall 52B of the peripheral wall 52 faces the lower surface 22B of the first main body 21. As depicted in FIG. 3, the first side wall 52C of the peripheral wall 52 faces the first side surface 22C of the first main body 21. The second side wall 52D of the peripheral wall 52 faces the second side surface 22D of the first main body 21.

As depicted in FIG. 1, the second locking portion 53 protrudes in the upward direction Z1 from the upper wall 52A of the peripheral wall 52. As depicted in FIG. 4, the second locking portion 53 is provided to cover part of the first locking portion 23. In more detail, the second locking portion 53 is provided to cover the ascending slope portion 25 of the first locking portion 23 and the locking hole 24. The second locking portion 53 includes a locking protrusion 54 that protrudes in the downward direction Z2 at a front end 53A thereof. The locking protrusion 54 is provided to be disposed inside the locking hole 24 of the first locking portion 23. When disposed inside the locking hole 24, the locking protrusion 54 engages the locking hole 24 in the unmating direction X2.

As depicted in FIGS. 1 to 3 and 5, the second housing 50 has an exposure hole 56. The exposure hole 56 is provided in the peripheral wall 52. In the connector 10 according to the present embodiment, the exposure hole 56 is provided in the upper wall 52A of the peripheral wall 52 and exposes part of the upper surface 22A of the first main body 21. The exposure hole 56 is rectangular in shape when viewed from above the second connector 12.

As depicted in FIG. 5, the exposure hole 56 is shaped such that the size (or “second hole width”) at an outer surface 52A2 of the upper wall 52A of the peripheral wall 52 is larger than the size (or “first hole width”) at an inner surface 52A1 of the upper wall 52A. In more detail, the exposure hole 56 has a first hole part 56A near the inner surface 52A1 and a second hole part 56B between the first hole part 56A and the outer surface 52A2. The first hole part 56A extends along the third axis Z. The first hole part 56A has a first hole width. The second hole part 56B is shaped so that its hole width gradually increases along the third axis Z from the first hole part 56A toward the outer surface 52A2. The hole width at the outer surface 52A2 is the “second hole width”. Note that the size of the exposure hole 56 is defined as the size required to expose a part of the upper surface 22A of the first main body 21. In the present embodiment, the size of the exposure hole 56 is indicated by the first hole width at the inner surface 52A1 of the upper wall 52A.

### (Mating of First Connector 11 and Second Connector 12)

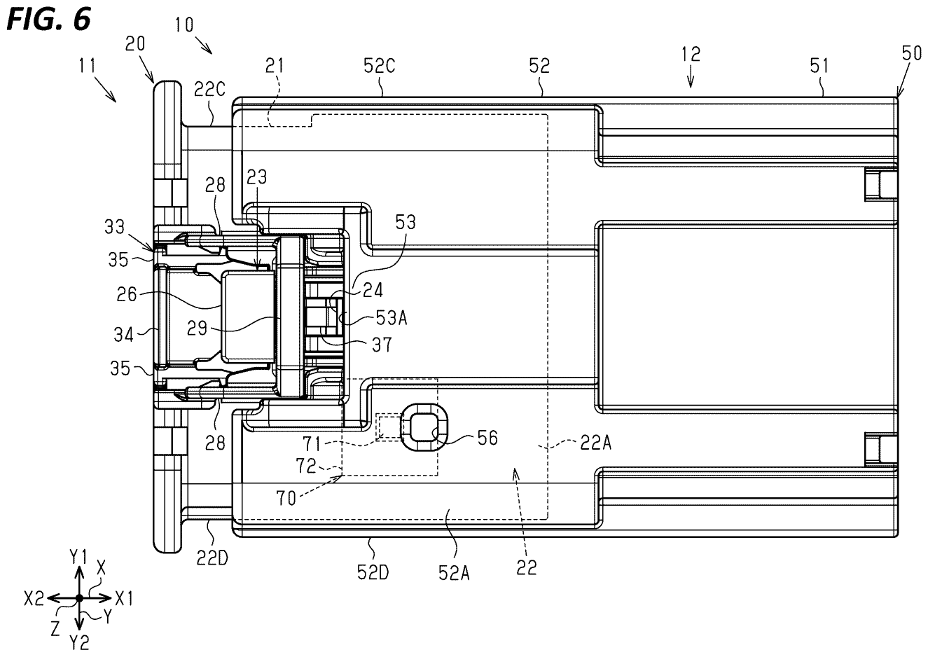

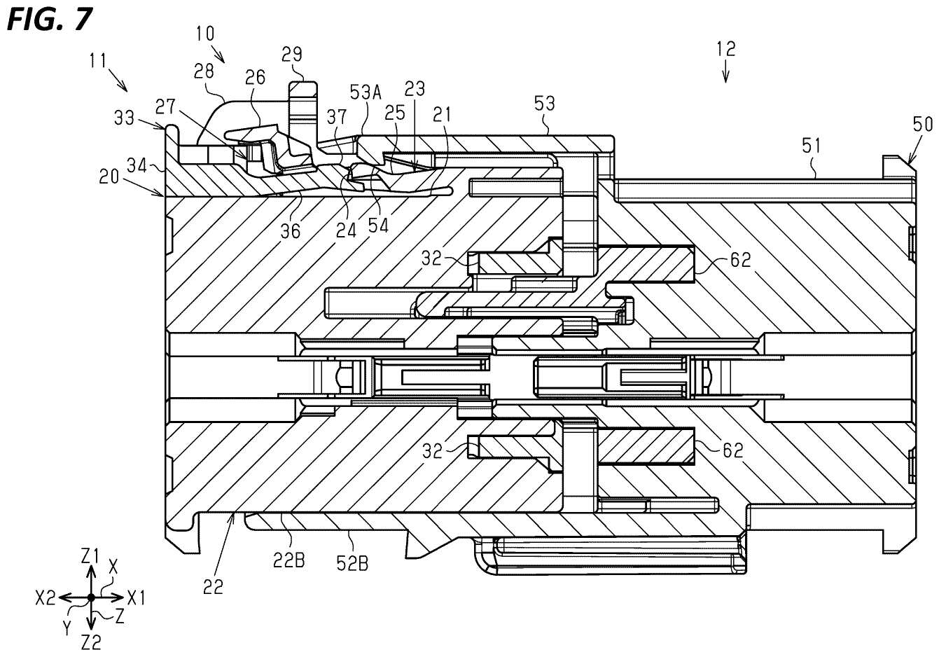

FIGS. 3 and 4 depict the first connector 11 and the second connector 12 in a state where mating has been completed. FIGS. 6 and 7 depict the first connector 11 and the second connector 12 in a mid-mating state, that is, a state where mating has not been completed.

As depicted in FIGS. 6 and 7, when mating has not been completed, the locking protrusion 54 on the second locking portion 53 of the second connector 12 presses the ascending slope portion 25 of the first locking portion 23 in the downward direction Z2. In this state where mating has not been completed, the first connector 11 can be separated from the second connector 12 by moving the first connector 11 in the unmating direction X2. Also, in this state where mating has not been completed, since the action protrusion 37 of the position securing member 33 engages the locking hole 24 of the first locking portion 23, movement of the position securing member 33 is prevented.

As depicted in FIGS. 3 and 4, when mating has been completed, the locking protrusion 54 of the second locking portion 53 is inserted into the locking hole 24 of the first locking portion 23. When this happens, the locking hole 24 of the first locking portion 23 and the locking protrusion 54 of the second locking portion 53 engage each other on the first axis X. In this state, the first locking portion 23 and the second locking portion 53 prevent relative movement between the first connector 11 and the second connector 12 along the first axis X. In other words, the first connector 11 and the second connector 12 are locked by the first locking portion 23 and the second locking portion 53.

In the state where the first connector 11 is mated with the second connector 12, the position securing member 33 is moved from the provisional locking position K1 to the full locking position K2, which prevents relative separation between the first connector 11 and the second connector 12.

As depicted in FIG. 4, when mating of the first connector 11 and the second connector 12 is complete, the action piece 36 is pressed in the downward direction Z2 by the second locking portion 53 of the second connector 12. By doing so, the action protrusion 37 is disengaged from the locking hole 24, which allows the position securing member 33 to move to the full locking position K2. When the action protrusion 37 and the locking hole 24 are disengaged, the first locking portion 23 is capable of elastic deformation in the downward direction Z2. This means that by pressing the operating portion 26 in the downward direction Z2, the second locking portion 53 disengages from the locking hole 24 in the unmating direction X2, which enables the second connector 12 and the first connector 11 to be relatively separated. In this way, when positioned at the provisional locking position K1, the position securing member 33 enables the first connector 11 and the second connector 12 to become relatively disengaged from each other.

When the position securing member 33 has moved to the full locking position K2 indicated by the dashed-dotted line, the action piece 36, which includes the action protrusion 37, is disposed between the first locking portion 23 and the first main body 21. The action piece 36 prevents elastic deformation of the first locking portion 23 in the downward direction Z2. By doing so, since the second locking portion 53 is prevented from becoming disengaged from the locking hole 24, relative separation of the second locking portion 53 of the second connector 12 and the first locking portion 23 is prevented. The position securing member 33 is held at the full locking position K2 by the protrusions provided on the pair of assembly pieces 35 and the protrusions provided on the pair of side walls 28 of the attachment portion 27. In this way, when positioned at the full locking position K2, the position securing member 33 prevents relative separation between the first connector 11 and the second connector 12.

### (Configuration of Identifier 70, First Code 71, and Second Code 72)

As depicted in FIGS. 1 to 3, the first connector 11 includes an identifier 70. The identifier 70 is provided on an exposed surface of the first main body 21. As one example, the identifier 70 is provided on the upper surface 22A of the first main body 21. As depicted in FIG. 3, the identifier 70 is provided on a part of the upper surface 22A of the first main body 21 that is covered by the second housing 50 of the second connector 12 in a state where the first connector 11 and the second connector 12 are prevented from being separated. In the connector 10 according to the present embodiment, the identifier 70 is provided in a central portion of the upper surface 22A of the first main body 21 along the first axis X.

The second housing 50 of the second connector 12 includes the exposure hole 56 that exposes part of the identifier 70. The exposure hole 56 is disposed at a position where part of the identifier 70 becomes exposed when mating of the first connector 11 and the second connector 12 has been completed. In more detail, the exposure hole 56 is disposed at a position that exposes a first code 71 and covers a second code 72 in the state where mating has been completed. Here, the expression “exposing the first code 71” refers to a state that enables the first code 71 to be read. As depicted in FIG. 6, when mating between the first connector 11 and the second connector 12 has not been completed, the exposure hole 56 is displaced in the mating direction X1 relative to the first code 71, so that the first code 71 is not exposed. In FIG. 6, the exposure hole 56 exposes part of the second code 72. When the first connector 11 has moved further in the unmating direction X2 compared to FIG. 6, the exposure hole 56 exposes the upper surface 22A of the second housing 50 without exposing the second code 72.

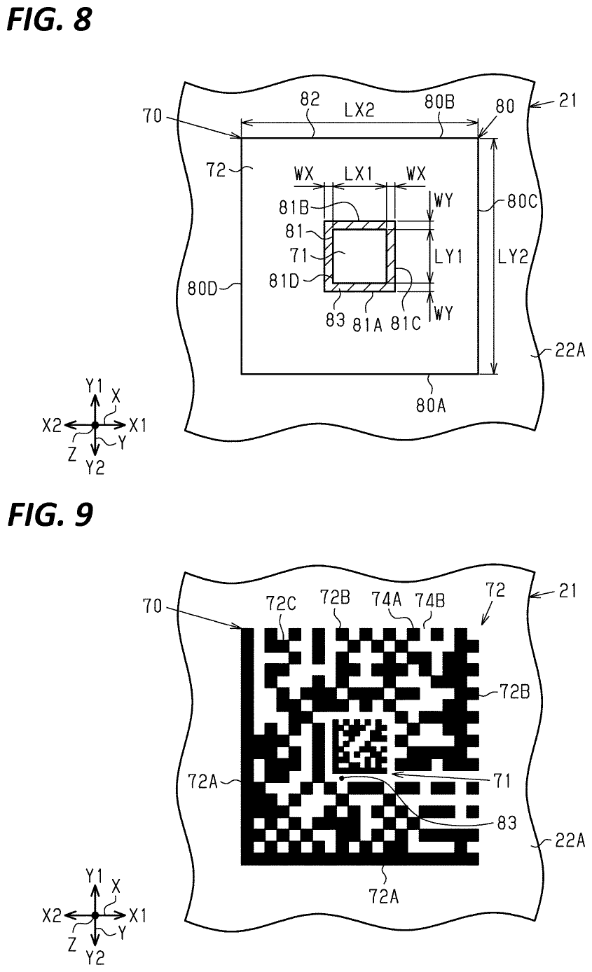

As depicted in FIGS. 8 to 11, the identifier 70 is positioned within a code region 80 set on the upper surface 22A of the first main body 21 of the first housing 20. The code region 80 is rectangular in shape when viewed from a direction along the third axis Z. As one example, the code region 80 is square. The code region 80 can be changed to another freely chosen shape, such as a rectangle.

As one example, the identifier 70 is disposed by performing laser machining on the upper surface 22A of the first main body 21. However, the method of disposing the identifier 70 may be changed as desired. As examples, the identifier 70 may be placed on the upper surface 22A of the first main body 21 by printing, or a plate-shaped code that is separate from the first housing 20 may be stuck onto the upper surface 22A of the first main body 21.

The code region 80 includes a first region 81 and a second region 82. In the present embodiment, the first region 81 is disposed in the center of the code region 80. The first region 81 is rectangular in shape when viewed from a direction along the third axis Z. In the present embodiment, the first region 81 is square. The second region 82 is disposed so as to surround the first region 81. In the present embodiment, the second region 82 has a rectangular annular shape. The first region 81 can be any freely chosen shape, such as a rectangle. The disposed location of the first region 81 can be freely changed. As one example, the first region 81 may be provided in a corner part of the code region 80.

The first code 71 depicted in FIG. 9 is disposed in the first region 81. The second code 72 depicted in FIG. 9 is disposed in the second region 82. The code region 80 in which the identifier 70 is disposed can be considered to include a first region 81 in which the first code 71 is disposed and a second region 82 in which the second code 72 is disposed.

The code region 80 includes a non-code region 83 provided between the first region 81 and the second region 82. The non-code region 83 is disposed to surround the first region 81. The non-code region 83 is annular and surrounds the first region 81. In the present embodiment, the non-code region 83 has a uniform width along the edges of the first region 81. However, the width of the non-code region 83 may vary in some parts.

The first code 71 and the second code 72 contain different information. The information in the first code 71 includes “Mating Completed” and “Lot Number”, for example. The information in the second code 72 includes “Mating Incomplete”, for example. Note that the information described above is merely one example of the information contained in the first code 71 and the second code 72. As another example, the second code 72 may include “Mating Incomplete” and “Lot Number”.

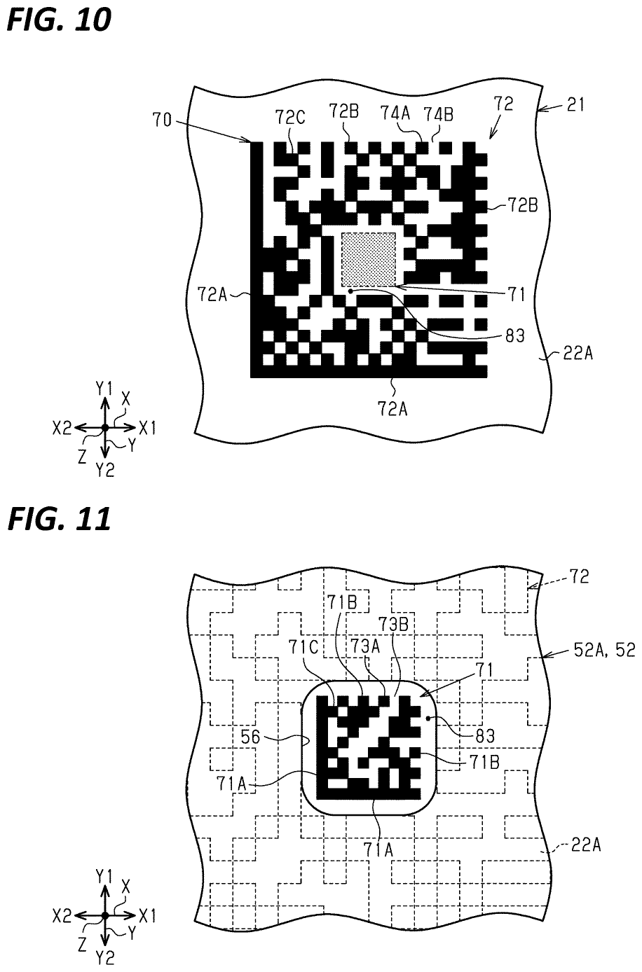

As depicted in FIGS. 9 and 10, the second code 72 may be a two-dimensional code, for example. As one example, a data matrix may be used as the two-dimensional code. A two-dimensional code aside from a data matrix may also be used as the second code 72. The second code 72 may also be a code aside from a two-dimensional code, such as a one-dimensional code or a three-dimensional code.

The second code 72 includes detection patterns 72A and 72B, which are provided in the outer periphery, and a data pattern 72C, which is surrounded by the detection patterns 72A and 72B. As one example, the detection patterns 72A indicate the area in which the data pattern 72C is disposed, and the detection patterns 72B indicate the arrangement of the data pattern 72C. These detection patterns 72A and 72B enable the data pattern 72C to be detected.

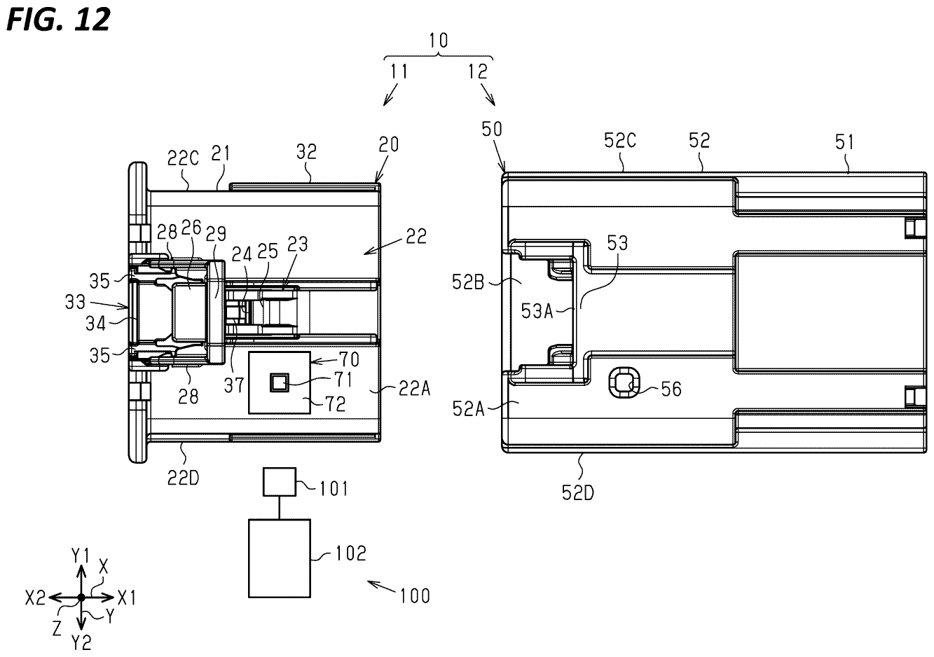

The detection patterns 72A, 72B, and the data pattern 72C are composed of first cells 74A and second cells 74B. In other words, the second code 72 is composed of a plurality of first cells 74A and a plurality of second cells 74B. The first cells 74A and the second cells 74B can be distinguished from each other by a detection apparatus 100 (see FIG. 12) that reads the identifier 70. As one example, the detection patterns 72A are composed of a plurality of the first cells 74A only, while the detection patterns 72B are composed of a plurality of the first cells 74A and a plurality of the second cells 74B. In FIGS. 9 to 11, the first cells 74A are depicted as black, and the second cells 74B are depicted as white. However, the colors of the first cells 74A and second cells 74B can be freely changed as desired. As one example, the second cells 74B may be the same color as the first main body 21 so long as the first cells 74A can be distinguished from the second cells 74B. In the present embodiment, the first cells 74A and the second cells 74B are square. However, the shapes of the first cells 74A and the second cells 74B can be freely changed as desired.

As depicted in FIGS. 9 and 11, the first code 71 is a two-dimensional code for example. Like the second code 72, a data matrix is used for example as the first code 71 in the present embodiment. However, two-dimensional codes aside from data matrices may also be used as the first code 71. The first code 71 may also be a code aside from a two-dimensional code, such as a one-dimensional code or a three-dimensional code.

As depicted in FIG. 11, the first code 71 includes detection patterns 71A and 71B and a data pattern 71C. The detection patterns 71A and 71B and the data pattern 71C are composed of first cells 73A and second cells 73B. In other words, the first code 71 is composed of a plurality of the first cells 73A and a plurality of the second cells 73B. The first cells 73A and the second cells 73B can be distinguished from each other by the detection apparatus 100 (see FIG. 12). In the present embodiment, the first cells 73A and the second cells 73B are square. However, the shapes of the first cell 73A and the second cell 73B can be freely changed as desired.

In the identifier 70 according to the present embodiment, the first cells 73A and the second cells 73B of the first code 71 differ in size from the first cells 74A and the second cells 74B of the second code 72. In the present embodiment, the first cells 73A and the second cells 73B of the first code 71 are smaller than the first cells 74A and the second cells 74B of the second code 72. The first region 81 in which the first code 71 is disposed is smaller than the second region 82 in which the second code 72 is disposed. Accordingly, by constructing the first code 71 using the first cells 73A and the second cells 73B that are smaller than the first cells 74A and the second cells 74B of the second code 72, it is possible to include a larger amount of information in the first code 71.

### (Reading the Identifier 70)

The identifier 70 is read by the detection apparatus 100 depicted in FIG. 12. As one example, the detection apparatus 100 includes a reader 101 that optically reads the identifier 70 and a recording apparatus 102 that records the information read by the reader 101.

As depicted in FIG. 12, the identifier 70 is read by the reader 101 in a state where the first connector 11 has been separated from the second connector 12. The recording apparatus 102 processes the code read by the reader 101.

In the state depicted in FIG. 12, every cell contained in the code region 80, that is, the second code 72 and the first code 71 surrounded by the second code 72, is read by the reader 101 and sent to the recording apparatus 102. The recording apparatus 102 displays the information contained in the code sent from the reader 101.

As depicted in FIG. 9, the identifier 70 includes the first code 71 and the second code 72 which is disposed so as to surround the first code 71. The recording apparatus 102 uses the detection patterns in the outer periphery parts of the identifier 70, that is, the detection patterns 72A and 72B of the second code 72, to determine the cells disposed in the part located inside the detection patterns 72A and 72B. Accordingly, it is possible to read the second code 72, which is composed of the first cells 74A and the second cells 74B that are the same size as the detection patterns 72B.

Also in the state depicted in FIG. 12, the second code 72 and the first code 71, which is composed of the first cells 73A and the second cells 73B that are smaller than in the second code 72, are read. The first code 71 is surrounded by the second code 72. Accordingly, the first code 71 can be recognized as part of the second code 72. In other words, the connector 10 according to the present embodiment prevents the first code 71 from being correctly read in a state where the entire identifier 70, that is, the first code 71 and the second code 72, is readable.

Like the relationship between the first code 71 and the second code 72, the two-dimensional code read by the reader 101 may contain, as error data, data that has been misread or data that was unreadable. In this case, the recording apparatus 102 may be incapable of obtaining the information contained in the two-dimensional code. For this reason, the recording apparatus 102 performs error correction on the two-dimensional code containing the error data, which enables the information contained in the two-dimensional code to be obtained.

The size of the first cells 73A and the second cells 73B that construct the first code 71 differs from the size of the first cells 74A and the second cells 74B that construct the second code 72. For this reason, the first code 71 is part of the second code 72 and can be recognized as an error code. The area of the first region 81 in which the first code 71 is disposed is 5% or less of the area of the code region 80 in which the identifier 70 is disposed. In this case, the recording apparatus 102 can obtain information on the second code 72 by performing error correction on the two-dimensional code that includes the first code 71 as error data. In other words, the connector 10 enables information on the second code 72 to be acquired by disposing the first code 71 in the first region 81 that is 5% or less of the area of the code region 80 in which the first code 71 and the second code 72 are disposed.

The recording apparatus 102 obtains information contained in the second code 72 by performing error correction on the code of the identifier 70. The information in the second code 72 includes “Mating incomplete”. Accordingly, if the recording apparatus 102 has read the entire identifier 70, a read error is displayed and the information is not recorded. A display of the recording apparatus 102 includes a display apparatus, such as an LCD, that displays text and graphics. Note that the display apparatus included in the recording apparatus 102 may also include an apparatus that uses LEDs or the like and display information by way of colors. In this way, the connector 10 of this embodiment prevents reading of the first code 71 and the recording of information from the first code 71 when mating of the first connector 11 and the second connector 12 has not been completed.

As depicted in FIG. 2, when mating of the first connector 11 and the second connector 12 has been completed, as depicted in FIG. 11, the second code 72 is covered by the second housing 50 of the second connector 12 and the first code 71 becomes exposed through the exposure hole 56. The first code 71 includes the detection patterns 71A and 71B. This means that the reader 101 of the detection apparatus 100 depicted in FIG. 12 can read the first code 71 using the detection patterns 71A and 71B. The recording apparatus 102 of the detection apparatus 100 depicted in FIG. 12 then obtains information including “Mating complete” and “Lot number” as the information included in the first code 71 read by the reader 101. The recording apparatus 102 displays that reading was successful and records such information. In this way, the connector 10 according to the present embodiment can reliably record that mating of the first connector 11 and the second connector 12 has been completed.

As depicted in FIG. 8, the code region 80 in which the identifier 70 is disposed includes the non-code region 83 between the first region 81 containing the first code 71 and the second region 82 containing the second code 72. As depicted in FIG. 11, the first code 71 is separated from the exposure hole 56 of the second housing 50 by the non-code region 83. Accordingly, the first code 71 can be fully exposed while reliably covering the second code 72. The width of the non-code region 83 may be equal to or greater than the size of the cells 73A and 73B that construct the first code 71.

### (Example Size of Identifier 70)

As depicted in FIG. 8, the code region 80 has a first side 80A and a second side 80B that extend along the first axis X and a third side 80C and a fourth side 80D that extend along the second axis Y. The length LX2 of the first side 80A and the second side 80B and the length LY2 of the third side 80C and the fourth side 80D are equal. The lengths LX2 and LY2 are 7 mm, for example. The first region 81 has a first side 81A and a second side 81B that extend along the first axis X, and a third side 81C and a fourth side 81D that extend along the second axis Y. The length LX1 of the first side 81A and the second side 81B and the length LY1 of the third side 81C and the fourth side 81D are equal, and the lengths LX1 and LY1 are 1.5 mm, for example. The non-code region 83 has a width WX along the first axis X and a width WY along the second axis Y. The widths WX and WY are 0.5 mm, for example.

### (Effects of the Present Embodiment)

The effects of the present embodiment are described below.

(1) The connector 10 includes the first connector 11 including the first housing 20 and the second connector 12 including the second housing 50. The first housing 20 includes the first main body 21, which is inserted into the second housing 50, and the first locking portion 23. The second housing 50 includes the peripheral wall 52, which covers the first main body 21, and the second locking portion 53. The first connector 11 includes the outer surface 22 that faces the peripheral wall 52 in a state where the peripheral wall 52 is covered by the first main body 21. The first connector 11 includes the first code 71 provided on the outer surface 22 and the second code 72 that includes different information from the first code 71 and is disposed on the outer surface 22 so as to surround the first code 71. The peripheral wall 52 includes the exposure hole 56 which is disposed so as to expose the first code 71 and cover the second code 72 in a state where mating of the first connector 11 and the second connector 12 by the first locking portion 23 and the second locking portion 53 has been completed.

With this configuration, in a state where mating of the first connector 11 and the second connector 12 has been completed, the second code 72 is covered by the second housing 50 in the periphery of the exposure hole 56, and the first code 71 is exposed through the exposure hole 56. This makes it possible to detect from the first code 71 that mating has been completed.

(2) The first code 71 and the second code 72 are composed of a plurality of cells 73A, 73B, 74A, and 74B, and the cells 73A and 73B of the first code 71 and the cells 74A and 74B of the second code 72 differ in size. This means that in a state where the first connector 11 and the second connector 12 are separated from each other, the second code 72 is exposed together with the first code 71. In this case, since the entire code 72 is detected by way of the second code 72 whose cells 73A, 73B, 74A, and 74B are different sizes, detection of the first code 71 is prevented.

(3) The cells 73A and 73B that construct the first code 71 are smaller than the cells 74A and 74B that construct the second code 72. Since the first code 71 contains information using the cells 73A and 73B, the small size of the cells 73A and 73B enables the first code 71 to contain the necessary information even when the area of the first code 71 surrounded by the second code 72 is small.

(4) The identifier includes the non-code region 83 provided between the first region 81 containing the first code 71 and the second region 82 containing the second code 72. This means the non-code region 83 enables the first code 71 to be exposed through the exposure hole 56 while the second code 72 remains covered.

(5) The non-code region 83 is annular and surrounds the first code 71. This means that the first code 71 can be more reliably exposed through the exposure hole 56 and the second code 72 can be more reliably covered, even when the first connector 11 is misaligned with respect to the second connector 12.

(6) The area of the first region 81 in which the first code 71 is disposed is 5% or less of the area of the code region 80 in which the first code 71 and the second code 72 are disposed. This means that in a state where the first code 71 and the second code 72 are exposed, the area of the first region 81 in which the first code 71 is disposed is smaller than the area of the second code 72, which makes it possible to read the second code 72 more reliably.

(7) The first connector 11 includes the position securing member 33 that is assembled onto the first housing 20 and is movable from the provisional locking position K1 to the full locking position K2 in a state where mating of the first connector 11 and the second connector 12 has been completed. When positioned at the provisional locking position K1, the position securing member 33 enables the first connector 11 and the second connector 12 to be relatively separated, and when positioned at the full locking position, the position securing member 33 prevents the first connector 11 and the second connector 12 from becoming relatively separated.

(8) The second hole width of the exposure hole 56 on the outer surface 52A2 of the upper wall 52A of the peripheral wall 52 is larger than the first hole width on the inner surface 52A1 of the upper wall 52A. Since it is possible to easily see the first code 71 from outside the second connector 12, it is possible to easily read the first code 71 with the reader 101.

### (Other Embodiments)

The embodiment described above can be modified as follows. The embodiment described above and the following modifications can be combined with each other within a range that remains technically consistent.
The size of the exposure hole 56 may be freely changed as desired, so long as the entire first code 71 can be read from the exposure hole 56 in a state where mating of the first connector 11 and the second connector 12 has been completed. So long as the entire first code 71 can be read from the exposure hole 56, the widths WX and WY of the non-code region 83 may be freely changed as desired and/or the non-code region 83 may be omitted.
The disposed positions of the identifier 70 (the first code 71 and the second code 72) and the exposure hole 56 may be freely changed as desired.

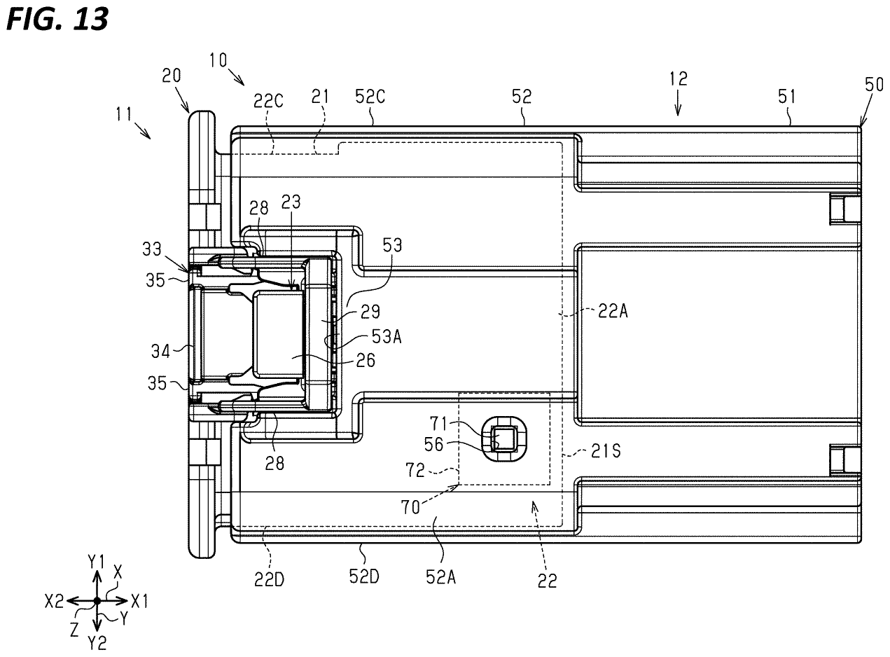

As depicted in FIG. 13, the identifier 70 (the first code 71 and the second code 72) may be disposed toward a front end 21S of the first main body 21 of the first connector 11 in the mating direction X1 of mating with the second connector 12. The exposure hole 56 may be disposed at a position which corresponds to the disposed position of the identifier 70 to expose the first code 71 and cover the second code 72.

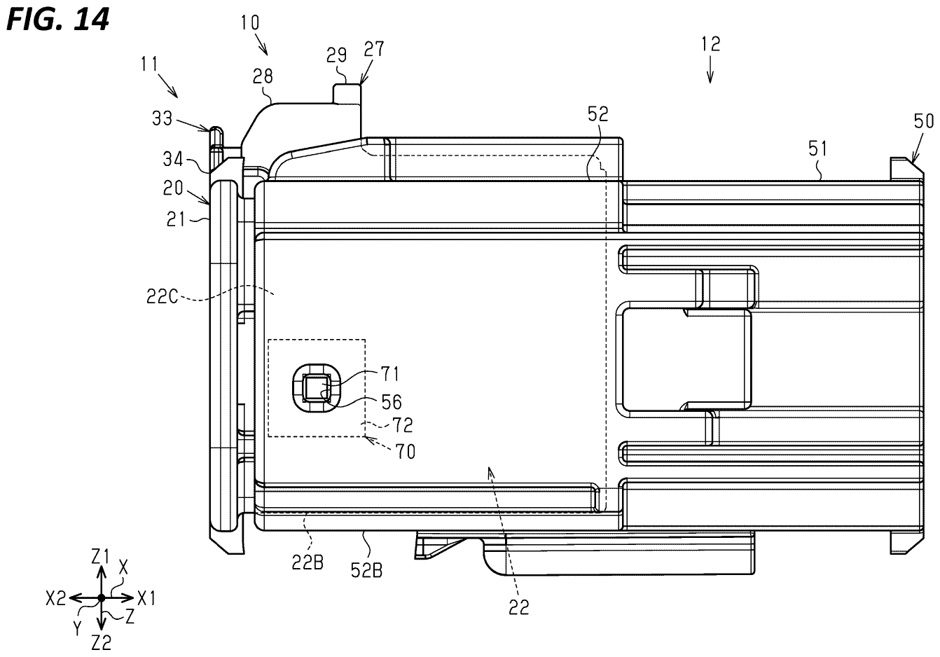

As depicted in FIG. 14, the identifier 70 (the first code 71 and the second code 72) may be disposed on the second side surface 22D of the first main body 21. The exposure hole 56 may be disposed on the second side wall 52D of the second housing 50. Note that although not illustrated, the identifier 70 (the first code 71 and the second code 72) may be disposed on the first side surface 22C of the first main body 21 depicted in FIG. 3. The exposure hole 56 may be disposed corresponding to the disposed position of the identifier 70 on the first side wall 52C of the second housing 50 depicted in FIG. 3.

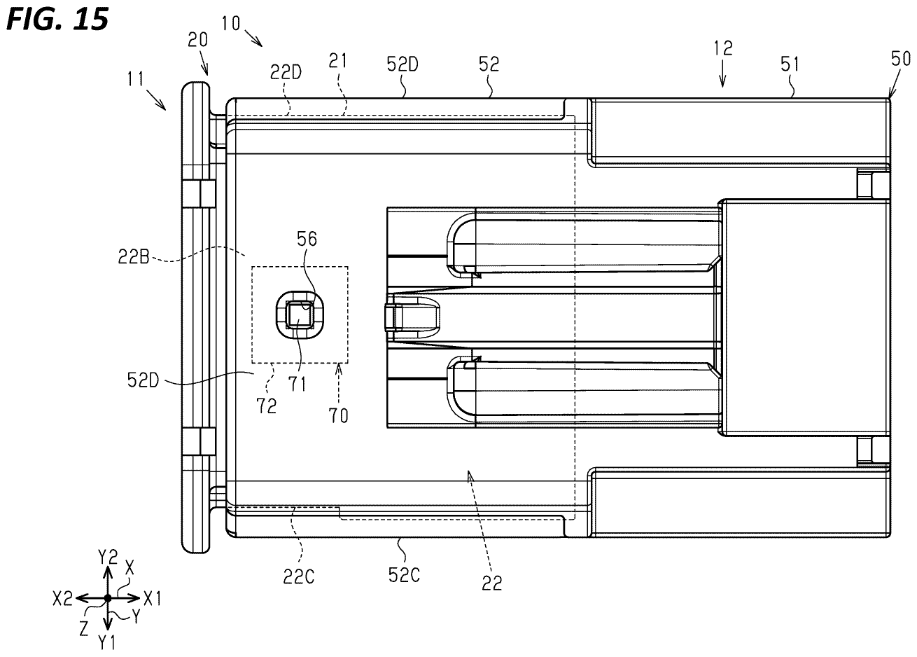

As depicted in FIG. 15, the identifier 70 (the first code 71 and the second code 72) may be disposed on the lower surface 22B of the first main body 21. The exposure hole 56 may be disposed corresponding to the disposed position of the identifier 70 on the lower wall 52B of the second housing 50.

Also, although not illustrated, the identifier 70 (the first code 71 and the second code 72) may be disposed on at least two or more surfaces out of the first main body 21, that is, the upper surface 22A, the lower surface 22B, the first side surface 22C, and the second side surface 22D. The exposure hole 56 may be disposed in two or more parts corresponding to the disposed positions of the identifier 70. With this configuration, since it is sufficient to visually identify one of the identifiers 70 and read the first code 71 of that identifier 70, it is possible to more easily read the identifier 70, which reduces the time required for the process of recording that mating has been completed.
The attachment portion 27 and the position securing member 33 may be omitted.
The disposed positions and/or shapes of the attachment portion 27 and the position securing member 33 can be freely changed. As one example, a lever may be used to prevent the first connector 11 and the second connector 12 from becoming relatively separated.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a first connector including a first housing; and
a second connector including a second housing into which the first housing is inserted,
wherein the first housing includes a first main body, which is inserted into the second housing, and a first locking portion,
the second housing includes a peripheral wall, which covers the first main body, and a second locking portion,
the first connector includes an outer surface that faces the peripheral wall in a state where the first main body is covered by the peripheral wall, a first code that is provided on the outer surface, and a second code that includes different information from the first code and is disposed on the outer surface so as to surround the first code, and
the peripheral wall includes an exposure hole that is disposed to expose the first code and cover the second code in a state where mating of the first connector and the second connector has been completed by the first locking portion and the second locking portion.

2. The connector according to claim 1,
wherein the first code and the second code are composed of a plurality of cells, and
the cells of the first code and the cells of the second code are respectively different sizes.

3. The connector according to claim 2,
wherein the cells that construct the first code are smaller than the cells that construct the second code.

4. The connector according to claim 1,
further comprising a non-code region provided between a first region where the first code is disposed and a second region where the second code is disposed.

5. The connector according to claim 4,
wherein the non-code region is annular and surrounds the first code.

6. The connector according to claim 1,
wherein an area of the first region where the first code is disposed is 5% or less of an area of a code region where the first code and the second code are disposed.

7. The connector according to claim 1,
wherein the first connector includes a position securing member that is assembled onto the first housing and is allowed to move from a provisional locking position to a full locking position in a state where mating of the first connector and the second connector has been completed.
